(19) United States
(12) Patent Application Publication
(10) Pub. No.: US 2022/0357861 A1
(43) Pub. Date: Nov. 10, 2022

(54) SERVICE MANAGEMENT SYSTEM FOR SCALING SERVICES BASED ON DEPENDENCY INFORMATION IN A DISTRIBUTED DATABASE

(71) Applicant: Dropbox, Inc., San Francisco, CA (US)

(72) Inventors: Jonathan Lee, Seattle, WA (US); Rajat Goel, San Jose, CA (US)

(21) Appl. No.: 17/316,565

(22) Filed: May 10, 2021

(51) Int. Cl. G06F 3/06

(52) U.S. Cl. CPC G06F 3/0631; G06F 3/0604; G06F 3/067

(57) ABSTRACT

A service management system manages scaling and migration of a plurality of services in a content management system. The service management system may maintain a plurality of services that are distributed across a plurality of clusters, each service serving a functionality in the content management system. Responsive to receiving a request to scale a service, the service management system may access dependency data describing dependencies among the plurality of services. Based on the dependency data, the service management system may determine a set of services to scale and determine a scaling sequence in which the set of services are to be scaled. The service management system may further determine other parameters for the scaling process such as scaling ratios, allocation ratios and scaling factors associated with the services and the scaling is further based on the parameters.

### TECHNICAL FIELD

The disclosed embodiments generally relate to database technologies, and particularly to a service management system that manages scaling and migration of services in a data storage system.

### BACKGROUND

Distributed database systems are commonly supported by several services (e.g. computing services, storage services, etc.) distributed across a plurality of clusters, each cluster including one or more processing units (e.g. physical and/or virtual machines). A service may receive requests from other services. If a service is overloaded with requests, the service may need to be scaled up with additional computing power (e.g. processing units) to handle those requests. However, because services may depend on each other, blindly scaling the service to accommodate the increase in demand might deteriorate or disable functionality of dependent services.

### SUMMARY

Systems and methods are disclosed herein for a service management system that manages scaling and migration of a plurality of services in a content management system. The service management system may maintain a plurality of services that are distributed across a plurality of clusters, each service serving a functionality in the content management system, such as serving a computing service or a storage service. Responsive to receiving a request to scale a service, the service management system may access dependency data (e.g. a dependency graph) describing dependencies among the plurality of services. Based on the dependency data, the service management system may determine a set of services to scale and determine a scaling sequence in which the set of services are to be scaled. The service management system may further determine other parameters for the scaling process such as scaling ratios, allocation ratios and scaling factors associated with the services and the scaling is further based on the parameters.

In one embodiment, the scaling sequence to scale the set of services is determined based on a direction of scaling for the service. The service management system may determine a direction of scaling (e.g. scale up or scale down) based on the request. Responsive to the request being scaling up the service, the service management system may scale the set of services in a bottom to top order (e.g. if service A depends on service B, then service A is on a higher tiered level than service B). Responsive to the request being scaling down the service, the service management system may scale the set of services in a top-to-bottom (e.g. higher tiered level to lower tiered level) order.

The systems and methods disclosed herein provide various technical advantages. For example, the systems and methods disclosed herein provide stability to the content management system by scaling the set of services based on dependency data. Although the request may be to scale one service, the system may coordinate the scaling process among a set of services that are affected by the service to be scaled based on their dependencies. The system may determine a specific order and various parameters such as scaling ratios and allocation ratios for the scaling process, such that the affected services may still function properly during the scaling process. Furthermore, the systems and methods disclosed herein may optimize utilization of computing and storage resources by scaling services based on the amount of workload that each service has. The system may allocate additional resources to a service if the service is overloaded and free up resources if a service does not require that much resources. As a result, the systems and methods disclosed herein provide stability to the content management system and efficiently utilize the limited amount of resources.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 shows a diagram of a system environment of a content management system and a collaborative content management system according to one example embodiment.

FIG. 2 shows a block diagram of components of a client device, according to one example embodiment.

FIG. 3 shows a block diagram of a content management system, according to one example embodiment.

FIG. 4 shows a block diagram of a collaborative content management system, according to one example embodiment.

FIG. 5 shows a block diagram of modules in a content item management system, according to one example embodiment.

FIG. 6 shows an exemplary initial configuration including several services, according to one example embodiment.

FIG. 7-9 illustrate a series of phases for scaling up service C, according to one example embodiment.

FIG. 10 illustrates an exemplary system including several services with non-linear dependency, according to one example embodiment.

FIG. 11 shows an exemplary process for scaling a service of a plurality of service, according to one example embodiment.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

System Overview

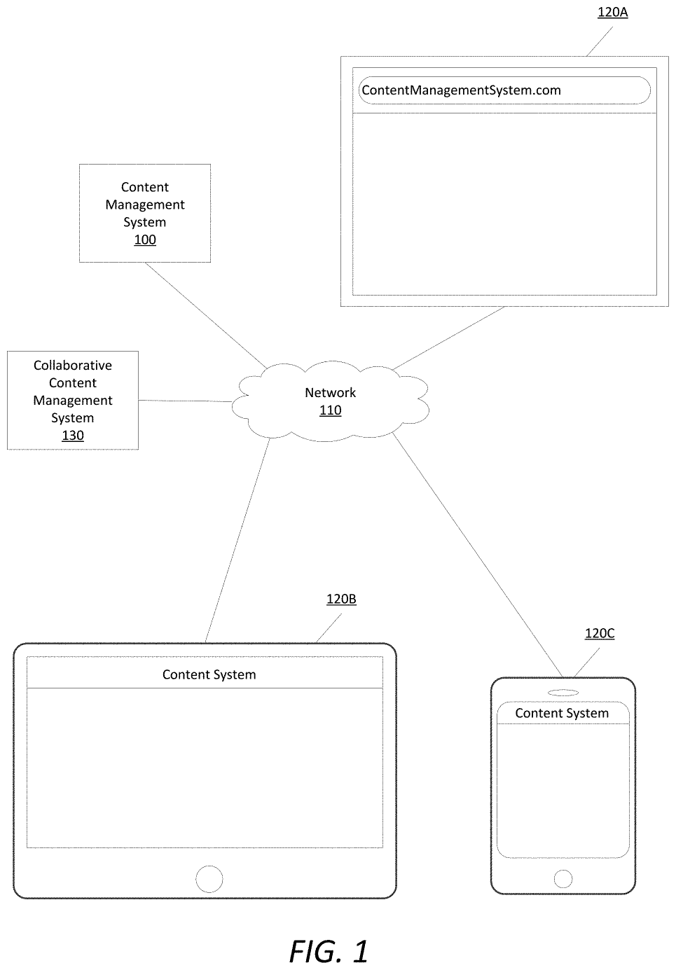

FIG. 1 shows a system environment including content management system 100, collaborative content management system 130, and client devices 120a, 120b, and 120c (collectively or individually “120”). Content management system 100 provides functionality for sharing content items with one or more client devices 120 and synchronizing content items between content management system 100 and one or more client devices 120.

The content stored by content management system 100 can include any type of content items, such as documents, spreadsheets, collaborative content items, text files, audio files, image files, video files, webpages, executable files, binary files, placeholder files that reference other content items, etc. In some implementations, a content item can be a portion of another content item, such as an image that is included in a document. Content items can also include collections, such as folders, namespaces, playlists, albums, etc., that group other content items together. The content stored by content management system 100 may be organized in one configuration in folders, tables, or in other database structures (e.g., object oriented, key/value etc.).

In one embodiment, the content stored by content management system 100 includes content items created by using third party applications, e.g., word processors, video and image editors, database management systems, spreadsheet applications, code editors, and so forth, which are independent of content management system 100.

In some embodiments, content stored by content management system 100 includes content items, e.g., collaborative content items, created using a collaborative interface provided by collaborative content management system 130. In various implementations, collaborative content items can be stored by collaborative content item management system 130, with content management system 100, or external to content management system 100. A collaborative interface can provide an interactive content item collaborative platform whereby multiple users can simultaneously create and edit collaborative content items, comment in the collaborative content items, and manage tasks within the collaborative content items.

Users may create accounts at content management system 100 and store content thereon by sending such content from client device 120 to content management system 100. The content can be provided by users and associated with user accounts that may have various privileges. For example, privileges can include permissions to: see content item titles, see other metadata for the content item (e.g. location data, access history, version history, creation/modification dates, comments, file hierarchies, etc.), read content item contents, modify content item metadata, modify content of a content item, comment on a content item, read comments by others on a content item, or grant or remove content item permissions for other users.

Client devices 120 communicate with content management system 100 and collaborative content management system 130 through network 110. The network may be any suitable communications network for data transmission. In one embodiment, network 110 is the Internet and uses standard communications technologies and/or protocols. Thus, network 110 can include links using technologies such as Ethernet, 802.11, worldwide interoperability for microwave access (WiMAX), 3G, 4G, digital subscriber line (DSL), asynchronous transfer mode (ATM), InfiniBand, PCI Express Advanced Switching, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

In some embodiments, content management system 100 and collaborative content management system 130 are combined into a single system. The system may include one or more servers configured to provide the functionality discussed herein for the systems 100 and 130.

### Client Device

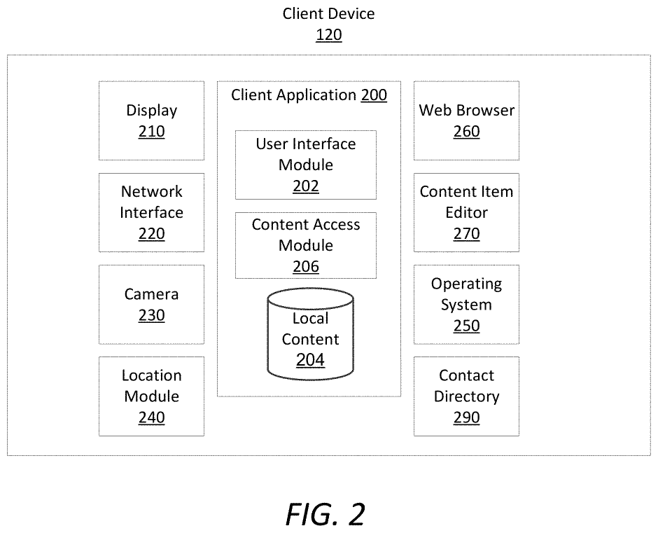

FIG. 2 shows a block diagram of the components of a client device 120 according to one embodiment. Client devices 120 generally include devices and modules for communicating with content management system 100 and a user of client device 120. Client device 120 includes display 210 for providing information to the user, and in certain client devices 120 includes a touchscreen. Client device 120 also includes network interface 220 for communicating with content management system 100 via network 110. There are additional components that may be included in client device 120 but that are not shown, for example, one or more computer processors, local fixed memory (RAM and ROM), as well as optionally removable memory (e.g., SD-card), power sources, and audio-video outputs.

In certain embodiments, client device 120 includes additional components such as camera 230 and location module 240. Location module 240 determines the location of client device 120, using, for example, a global positioning satellite signal, cellular tower triangulation, or other methods. Location module 240 may be used by client application 200 to obtain location data and add the location data to metadata about a content item.

Client devices 120 maintain various types of components and modules for operating the client device and accessing content management system 100. The software modules can include operating system 250 or a collaborative content item editor 270. Collaborative content item editor 270 is configured for creating, viewing and modifying collaborative content items such as text documents, code files, mixed media files (e.g., text and graphics), presentations or the like. Operating system 250 on each device provides a local file management system and executes the various software modules such as content management system client application 200 and collaborative content item editor 270. A contact directory 290 stores information on the user's contacts, such as name, telephone numbers, company, email addresses, physical address, website URLs, and the like.

Client devices 120 access content management system 100 and collaborative content management system 130 in a variety of ways. Client device 120 may access these systems through a native application or software module, such as content management system client application 200. Client device 120 may also access content management system 100 through web browser 260. As an alternative, the client application 200 may integrate access to content management system 100 with the local file management system provided by operating system 250. When access to content management system 100 is integrated in the local file management system, a file organization scheme maintained at the content management system is represented at the client device 120 as a local file structure by operating system 250 in conjunction with client application 200.

Client application 200 manages access to content management system 100 and collaborative content management system 130. Client application 200 includes user interface module 202 that generates an interface to the content accessed by client application 200 and is one means for performing this function. The generated interface is provided to the user by display 210. Client application 200 may store content accessed from a content storage at content management system 100 in local content 204. While represented here as within client application 200, local content 204 may be stored with other data for client device 120 in non-volatile storage. When local content 204 is stored this way, the content is available to the user and other applications or modules, such as collaborative content item editor 270, when client application 200 is not in communication with content management system 100. Content access module 206 manages updates to local content 204 and communicates with content management system 100 to synchronize content modified by client device 120 with content maintained on content management system 100, and is one means for performing this function. Client application 200 may take various forms, such as a stand-alone application, an application plug-in, or a browser extension.

### Content Management System

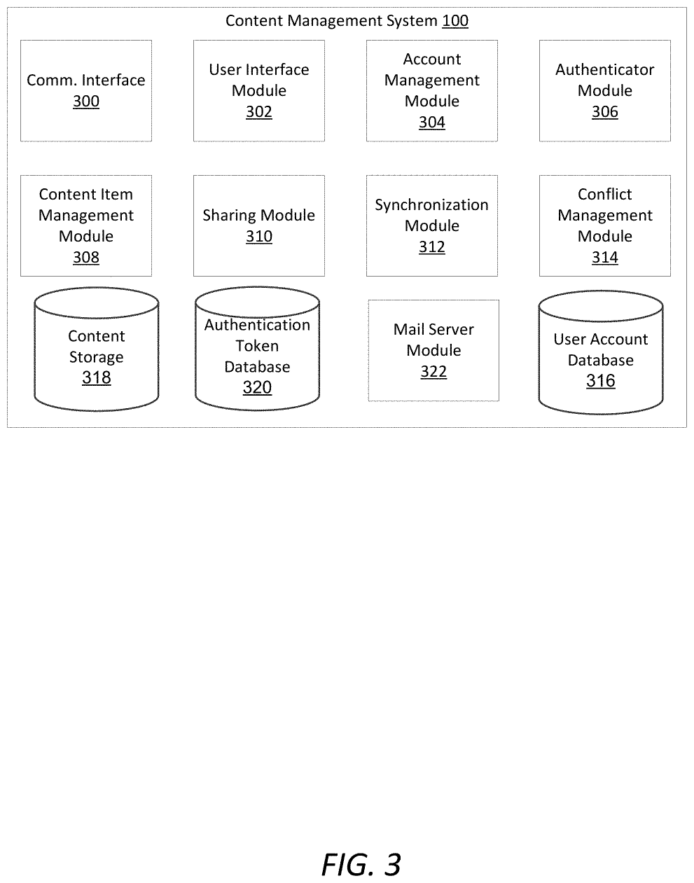

FIG. 3 shows a block diagram of the content management system 100 according to one embodiment. To facilitate the various content management services, a user can create an account with content management system 100. The account information can be maintained in user account database 316, and is one means for performing this function. User account database 316 can store profile information for registered users. In some cases, the only personal information in the user profile is a username and/or email address. However, content management system 100 can also be configured to accept additional user information, such as password recovery information, demographics information, payment information, and other details. Each user is associated with a userID and a username. For purposes of convenience, references herein to information such as collaborative content items or other data being “associated” with a user are understood to mean an association between a collaborative content item and either of the above forms of user identifier for the user. Similarly, data processing operations on collaborative content items and users are understood to be operations performed on derivative identifiers such as collaborativeContentItemID and userIDs. For example, a user may be associated with a collaborative content item by storing the information linking the userID and the collaborativeContentItemID in a table, file, or other storage formats. For example, a database table organized by collaborativeContentItemIDs can include a column listing the userID of each user associated with the collaborative content item. As another example, for each userID, a file can list a set of collaborativeContentItemID associated with the user. As another example, a single file can list key values pairs such as <userID, collaborativeContentItemID>representing the association between an individual user and a collaborative content item. The same types of mechanisms can be used to associate users with comments, threads, text elements, formatting attributes, and the like.

User account database 316 can also include account management information, such as account type, e.g. free or paid; usage information for each user, e.g., file usage history; maximum storage space authorized; storage space used; content storage locations; security settings; personal configuration settings; content sharing data; etc. Account management module 304 can be configured to update and/or obtain user account details in user account database 316. Account management module 304 can be configured to interact with any number of other modules in content management system 100.

An account can be used to store content items, such as collaborative content items, audio files, video files, etc., from one or more client devices associated with the account. Content items can be shared with multiple users and/or user accounts. In some implementations, sharing a content item can include associating, using sharing module 310, the content item with two or more user accounts and providing for user permissions so that a user that has authenticated into one of the associated user accounts has a specified level of access to the content item. That is, the content items can be shared across multiple client devices of varying type, capabilities, operating systems, etc. The content items can also be shared across varying types of user accounts.

Individual users can be assigned different access privileges to a content item shared with them, as discussed above. In some cases, a user's permissions for a content item can be explicitly set for that user. A user's permissions can also be set based on: a type or category associated with the user (e.g., elevated permissions for administrator users or manager), the user's inclusion in a group or being identified as part of an organization (e.g., specified permissions for all members of a particular team), and/or a mechanism or context of a user's accesses to a content item (e.g., different permissions based on where the user is, what network the user is on, what type of program or API the user is accessing, whether the user clicked a link to the content item, etc.). Additionally, permissions can be set by default for users, user types/groups, or for various access mechanisms and contexts.

In some implementations, shared content items can be accessible to a recipient user without requiring authentication into a user account. This can include sharing module 310 providing access to a content item through activation of a link associated with the content item or providing access through a globally accessible shared folder.

The content can be stored in content storage 318, which is one means for performing this function. Content storage 318 can be a storage device, multiple storage devices, or a server. Alternatively, content storage 318 can be a cloud storage provider or network storage accessible via one or more communications networks. The cloud storage provider or network storage may be owned and managed by the content management system 100 or by a third party. In one configuration, content management system 100 stores the content items in the same organizational structure as they appear on the client device. However, content management system 100 can store the content items in its own order, arrangement, or hierarchy.

Content storage 318 can also store metadata describing content items, content item types, and the relationship of content items to various accounts, folders, or groups. The metadata for a content item can be stored as part of the content item or can be stored separately. In one configuration, each content item stored in content storage 318 can be assigned a system-wide unique identifier.

Content storage 318 can decrease the amount of storage space required by identifying duplicate files or duplicate segments of files. Instead of storing multiple copies of an identical content item, content storage 318 can store a single copy and then use a pointer or other mechanism to link the duplicates to the single copy. Similarly, content storage 318 stores files using a file version control mechanism that tracks changes to files, different versions of files (such as a diverging version tree), and a change history. The change history can include a set of changes that, when applied to the original file version, produces the changed file version.

Content storage 318 may further decrease the amount of storage space required by deleting content items based on expiration time of the content items. An expiration time for a content item may indicate that the content item is no longer needed after the expiration time and may therefore be deleted. Content storage 318 may periodically scan through the content items and compare expiration time with current time. If the expiration time of a content item is earlier than the current time, content storage 318 may delete the content item from content storage 318.

Content management system 100 automatically synchronizes content from one or more client devices, using synchronization module 312, which is one means for performing this function. The synchronization is platform agnostic. That is, the content is synchronized across multiple client devices 120 of varying type, capabilities, operating systems, etc. For example, client application 200 synchronizes, via synchronization module 312 at content management system 100, content in client device 120's file system with the content in an associated user account on system 100. Client application 200 synchronizes any changes to content in a designated folder and its sub-folders with the synchronization module 312. Such changes include new, deleted, modified, copied, or moved files or folders. Synchronization module 312 also provides any changes to content associated with client device 120 to client application 200. This synchronizes the local content at client device 120 with the content items at content management system 100.

Conflict management module 314 determines whether there are any discrepancies between versions of a content item located at different client devices 120. For example, when a content item is modified at one client device and a second client device, differing versions of the content item may exist at each client device. Synchronization module 312 determines such versioning conflicts, for example by identifying the modification time of the content item modifications. Conflict management module 314 resolves the conflict between versions by any suitable means, such as by merging the versions, or by notifying the client device of the later-submitted version.

A user can also view or manipulate content via a web interface generated by user interface module 302. For example, the user can navigate in web browser 260 to a web address provided by content management system 100. Changes or updates to content in content storage 318 made through the web interface, such as uploading a new version of a file, are synchronized back to other client devices 120 associated with the user's account. Multiple client devices 120 may be associated with a single account and files in the account are synchronized between each of the multiple client devices 120.

Content management system 100 includes communications interface 300 for interfacing with various client devices 120, and with other content and/or service providers via an Application Programming Interface (API), which is one means for performing this function. Certain software applications access content storage 318 via an API on behalf of a user. For example, a software package, such as an app on a smartphone or tablet computing device, can programmatically make calls directly to content management system 100, when a user provides credentials, to read, write, create, delete, share, or otherwise manipulate content. Similarly, the API can allow users to access all or part of content storage 318 through a web site.

Content management system 100 can also include authenticator module 306, which verifies user credentials, security tokens, API calls, specific client devices, etc., to determine whether access to requested content items is authorized, and is one means for performing this function. Authenticator module 306 can generate one-time use authentication tokens for a user account. Authenticator module 306 assigns an expiration period or date to each authentication token. In addition to sending the authentication tokens to requesting client devices, authenticator module 306 can store generated authentication tokens in authentication token database 320. After receiving a request to validate an authentication token, authenticator module 306 checks authentication token database 320 for a matching authentication token assigned to the user. Once the authenticator module 306 identifies a matching authentication token, authenticator module 306 determines if the matching authentication token is still valid. For example, authenticator module 306 verifies that the authentication token has not expired or was not marked as used or invalid. After validating an authentication token, authenticator module 306 may invalidate the matching authentication token, such as a single-use token. For example, authenticator module 306 can mark the matching authentication token as used or invalid, or delete the matching authentication token from authentication token database 320.

In some embodiments, content management system 100 includes a content item management module 308 for maintaining a content directory that identifies the location of each content item in content storage 318, and allows client applications to request access to content items in the storage 318, and which is one means for performing this function. A content entry in the content directory can also include a content pointer that identifies the location of the content item in content storage 318. For example, the content entry can include a content pointer designating the storage address of the content item in memory. In some embodiments, the content entry includes multiple content pointers that point to multiple locations, each of which contains a portion of the content item.

In addition to a content path and content pointer, a content entry in some configurations also includes user account identifier that identifies the user account that has access to the content item. In some embodiments, multiple user account identifiers can be associated with a single content entry indicating that the content item has shared access by the multiple user accounts.

In one embodiment, content item management module 308 manages scaling and migration of services distributed across clusters. Content item management module 308 may include services that perform various functionalities to support the content item management module 308. Some examples of functionalities of the services may include providing storage capacity for content items, partitioning content items into blocks for storage, encrypting and compressing blocks, managing blocks (e.g. retrieving corresponding blocks based on a request to retrieve a content item), etc. The various services may require different amount of resources such as computing power or storage capacity based on their respective functionalities. The amount of resources that a service uses for deployment may be referred to as deployment size.

In one embodiment, each service may receive and send requests to one or more other services. If a first service receives and processes requests from a second service, then the second service may be referred to as being dependent on the first service because the second service depends on the first service for processing information. A service may be associated with a list of requests to be processed. The amount of work that a service needs to process may be referred to as workload of the service. A service may be further associated with a capacity that indicates a percentage that the service is utilized. For example, a service may be at 80% capacity which indicates that the service has used 80% of the resources assigned to the service. In one embodiment, each service is associated with a pre-determined threshold of utilization percentage (e.g. 80%) indicating that the service is approaching its maximum capacity. Responsive to a service reaching the pre-determined threshold of utilization, load balancing module 560 of the content item management module 308 may scale up the service to handle the workload.

In one embodiment, the various services in content item management module 308 may be distributed across a plurality of clusters. Each cluster may include one or more servers and/or devices that may supply computing power and/or storage capacity for services. Each cluster is associated with an availability that indicates the amount of resources the cluster is capable to provide. In one embodiment, a service may be distributed across one or more clusters and the ratio of the service allocated on each cluster may be referred to as an allocation ratio. For example, 60% of service A may be processed by a first cluster and 40% percent of service A may be processed by a second cluster. The ratio 6:4 may be referred to as the allocation ratio for service A.

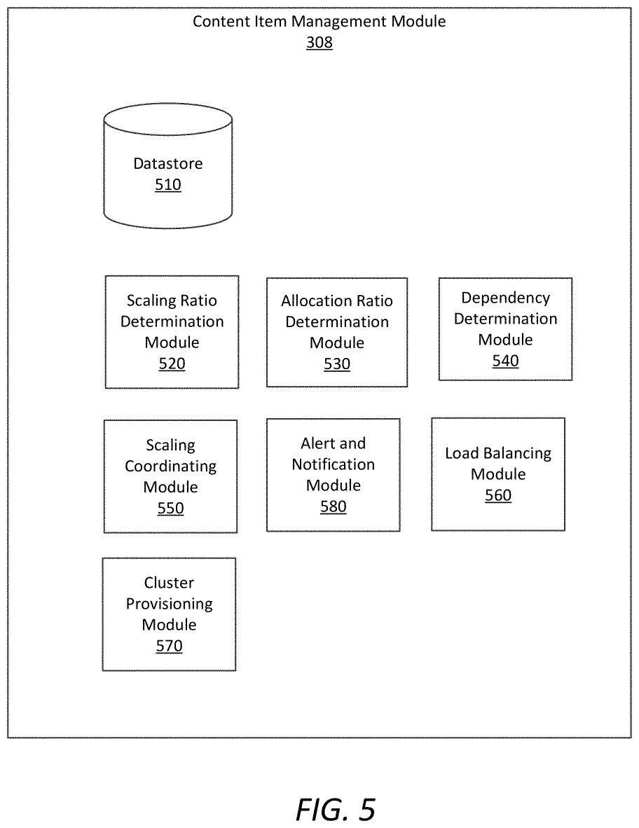

In one embodiment, content item management module 318 manages scaling of the services based on dependency data. Dependency data describes the dependencies among various services. For example, dependency data may include information such as a first service depends on a second service, which further depends on a third service. Multiple services may depend on a same service and a service may depend on more than one services. Content item management module 318 may use dependency data to coordinate scaling of services. Further details regarding scaling and dependency determination are discussed in further details in accordance with FIG. 5.

In some embodiments, the content management system 100 can include a mail server module 322. The mail server module 322 can send (and receive) collaborative content items to (and from) other client devices using the collaborative content management system 100. The mail server module can also be used to send and receive messages between users in the content management system.

### Collaborative Content Management System

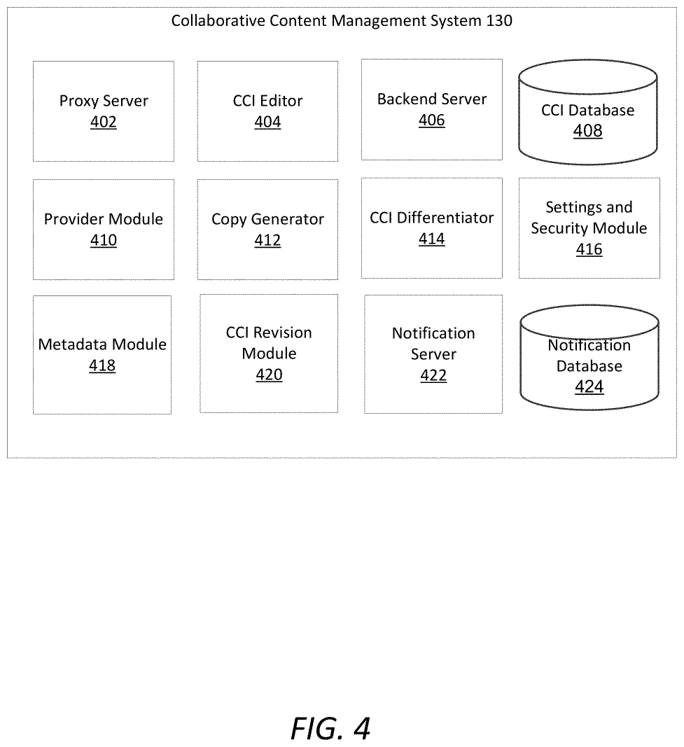

FIG. 4 shows a block diagram of the collaborative content management system 130, according to one embodiment. Collaborative content items can be files that users can create and edit using a collaborative content items editor 270 and can contain collaborative content item elements. Collaborative content item elements may include any type of content such as text; images, animations, videos, audio, or other multi-media; tables; lists; references to external content; programming code; tasks; tags or labels; comments; or any other type of content. Collaborative content item elements can be associated with an author identifier, attributes, interaction information, comments, sharing users, etc. Collaborative content item elements can be stored as database entities, which allows for searching and retrieving the collaborative content items. As with other types of content items, collaborative content items may be shared and synchronized with multiple users and client devices 120, using sharing 310 and synchronization 312 modules of content management system 100. Users operate client devices 120 to create and edit collaborative content items, and to share collaborative content items with other users of client devices 120. Changes to a collaborative content item by one client device 120 are propagated to other client devices 120 of users associated with that collaborative content item.

In the embodiment of FIG. 1, collaborative content management system 130 is shown as separate from content management system 100 and can communicate with it to obtain its services. In other embodiments, collaborative content management system 130 is a subsystem of the component of content management system 100 that provides sharing and collaborative services for various types of content items. User account database 316 and authentication token database 320 from content management system 100 are used for accessing collaborative content management system 130 described herein.

Collaborative content management system 130 can include various servers for managing access and edits to collaborative content items and for managing notifications about certain changes made to collaborative content items. Collaborative content management system 130 can include proxy server 402, collaborative content item editor 404, backend server 406, and collaborative content item database 408, access link module 410, copy generator 412, collaborative content item differentiator 414, settings module 416, metadata module 418, revision module 420, notification server 422, and notification database 424. Proxy server 402 handles requests from client applications 200 and passes those requests to the collaborative content item editor 404. Collaborative content item editor 404 manages application level requests for client applications 200 for editing and creating collaborative content items, and selectively interacts with backend servers 406 for processing lower level processing tasks on collaborative content items, and interfacing with collaborative content items database 408 as needed. Collaborative content items database 408 contains a plurality of database objects representing collaborative content items, comment threads, and comments. Each of the database objects can be associated with a content pointer indicating the location of each object within the CCI database 408. Notification server 422 detects actions performed on collaborative content items that trigger notifications, creates notifications in notification database 424, and sends notifications to client devices.

Client application 200 sends a request relating to a collaborative content item to proxy server 402. Generally, a request indicates the userID (“UID”) of the user, and the collaborativeContentItemID (“NID”) of the collaborative content item, and additional contextual information as appropriate, such as the text of the collaborative content item. When proxy server 402 receives the request, the proxy server 402 passes the request to the collaborative content item editor 404. Proxy server 402 also returns a reference to the identified collaborative content items proxy server 402 to client application 200, so the client application can directly communicate with the collaborative content item editor 404 for future requests. In an alternative embodiment, client application 200 initially communicates directly with a specific collaborative content item editor 404 assigned to the userID.

When collaborative content item editor 404 receives a request, it determines whether the request can be executed directly or by a backend server 406. When the request adds, edits, or otherwise modifies a collaborative content item the request is handled by the collaborative content item editor 404. If the request is directed to a database or index inquiry, the request is executed by a backend server 406. For example, a request from client device 120 to view a collaborative content item or obtain a list of collaborative content items responsive to a search term is processed by backend server 406.

The access module 410 receives a request to provide a collaborative content item to a client device. In one embodiment, the access module generates an access link to the collaborative content item, for instance in response to a request to share the collaborative content item by an author. The access link can be a hyperlink including or associated with the identification information of the CCI (i.e., unique identifier, content pointer, etc.). The hyperlink can also include any type of relevant metadata within the content management system (i.e., author, recipient, time created, etc.). In one embodiment, the access module can also provide the access link to user accounts via the network 110, while in other embodiments the access link can be provided or made accessible to a user account and is accessed through a user account via the client device. In one embodiment, the access link will be a hyperlink to a landing page (e.g., a webpage, a digital store front, an application login, etc.) and activating the hyperlink opens the landing page on a client device. The landing page can allow client devices not associated with a user account to create a user account and access the collaborative content item using the identification information associated with the access link. Additionally, the access link module can insert metadata into the collaborative content item, associate metadata with the collaborative content item, or access metadata associated with the collaborative content item that is requested.

The access module 410 can also provide collaborative content items via other methods. For example, the access module 410 can directly send a collaborative content item to a client device or user account, store a collaborative content item in a database accessible to the client device, interact with any module of the collaborative content management system to provide modified versions of collaborative content items (e.g., the copy generator 412, the CCI differentiator 414, etc.), sending content pointer associated with the collaborative content item, sending metadata associated with the collaborative content item, or any other method of providing collaborative content items between devices in the network. The access module can also provide collaborative content items via a search of the collaborative content item database (i.e., search by a keyword associated with the collaborative content item, the title, or a metadata tag, etc.).

The copy generator 412 can duplicate a collaborative content item. Generally, the copy generator duplicates a collaborative content item when a client device selects an access link associated with the collaborative content item. The copy generator 412 accesses the collaborative content item associated with the access link and creates a derivative copy of the collaborative content item for every request received. The copy generator 412 stores each derivative copy of the collaborative content item in the collaborative content item database 408. Generally, each copy of the collaborative content item that is generated by the copy generator 412 is associated with both the client device from which the request was received and the user account associated with the client device requesting the copy. When the copy of the collaborative content item is generated it can create a new unique identifier and content pointer for the copy of the collaborative content item. Additionally, the copy generator 412 can insert metadata into the collaborative content item, associate metadata with the copied collaborative content item, or access metadata associated with the collaborative content item that was requested to be copied.

The collaborative content item differentiator 414 determines the difference between two collaborative content items. In one embodiment, the collaborative content item differentiator 414 determines the difference between two collaborative content items when a client device selects an access hyperlink and accesses a collaborative content item that the client device has previously used the copy generator 412 to create a derivative copy. The content item differentiator can indicate the differences between the content elements of the compared collaborative content items. The collaborative content item differentiator 414 can create a collaborative content item that includes the differences between the two collaborative content items, i.e. a differential collaborative content item. In some embodiments, the collaborative content item differentiator provides the differential collaborative content item to a requesting client device 120. The differentiator 414 can store the differential collaborative content item in the collaborative content item database 408 and generate identification information for the differential collaborative content item. Additionally, the differentiator 414 can insert metadata into the accessed and created collaborative content items, associate metadata with the accessed and created collaborative content item, or access metadata associated with the collaborative content items that were requested to be differentiated.

The settings and security module 416 can manage security during interactions between client devices 120, the content management system 100, and the collaborative content management system 130. Additionally, the settings and security module 416 can manage security during interactions between modules of the collaborative content management system. For example, when a client device 120 attempts to interact within any module of the collaborative content management system 100, the settings and security module 416 can manage the interaction by limiting or disallowing the interaction. Similarly, the settings and security module 416 can limit or disallow interactions between modules of the collaborative content management system 130. Generally, the settings and security module 416 accesses metadata associated with the modules, systems 100 and 130, devices 120, user accounts, and collaborative content items to determine the security actions to take. Security actions can include: requiring authentication of client devices 120 and user accounts, requiring passwords for content items, removing metadata from collaborative content items, preventing collaborative content items from being edited, revised, saved or copied, or any other security similar security action. Additionally, settings and security module can access, add, edit or delete any type of metadata associated with any element of content management system 100, collaborative content management system 130, client devices 120, or collaborative content items.

The metadata module 418 manages metadata within with the collaborative content management system. Generally, metadata can take three forms within the collaborative content management system: internal metadata, external metadata, and device metadata. Internal metadata is metadata within a collaborative content item, external metadata is metadata associated with a CCI but not included or stored within the CCI itself, and device metadata is associated with client devices. At any point the metadata module can manage metadata by changing, adding, or removing metadata.

Some examples of internal metadata can be: identifying information within collaborative content items (e.g., email addresses, names, addresses, phone numbers, social security numbers, account or credit card numbers, etc.); metadata associated with content elements (e.g., location, time created, content element type; content element size; content element duration, etc.); comments associated with content elements (e.g., a comment giving the definition of a word in a collaborative content item and its attribution to the user account that made the comment); or any other metadata that can be contained within a collaborative content item.

Some examples of external metadata can be: content tags indicating categories for the metadata; user accounts associated with a CCI (e.g., author user account, editing user account, accessing user account etc.); historical information (e.g., previous versions, access times, edit times, author times, etc.); security settings; identifying information (e.g., unique identifier, content pointer); collaborative content management system 130 settings; user account settings; or any other metadata that can be associated with the collaborative content item.

Some examples of device metadata can be: device type; device connectivity; device size; device functionality; device sound and display settings; device location; user accounts associated with the device; device security settings; or any other type of metadata that can be associated with a client device 120.

The collaborative content item revision module 420 manages application level requests for client applications 200 for revising differential collaborative content items and selectively interacts with backend servers 406 for processing lower level processing tasks on collaborative content items, and interfacing with collaborative content items database 408 as needed. The revision module can create a revised collaborative content item that is some combination of the content elements from the differential collaborative content item. The revision module 420 can store the revised collaborative content item in the collaborative content item database or provide the revised collaborative content item to a client device 120. Additionally, the revision module 420 can insert metadata into the accessed and created collaborative content items, associate metadata with the accessed and created collaborative content item, or access metadata associated with the collaborative content items that were requested to be differentiated.

Content management system 100 and collaborative content management system 130 may be implemented using a single computer, or a network of computers, including cloud-based computer implementations. The operations of content management system 100 and collaborative content management system 130 as described herein can be controlled through either hardware or through computer programs installed in computer storage and executed by the processors of such server to perform the functions described herein. These systems include other hardware elements necessary for the operations described here, including network interfaces and protocols, input devices for data entry, and output devices for display, printing, or other presentations of data, but which are not described herein. Similarly, conventional elements, such as firewalls, load balancers, collaborative content items servers, failover servers, network management tools and so forth are not shown so as not to obscure the features of the system. Finally, the functions and operations of content management system 100 and collaborative content management system 130 are sufficiently complex as to require implementation on a computer system and cannot be performed in the human mind simply by mental steps.

### Content Item Management Module

FIG. 5 illustrates an example embodiment of content item management module 308. The content item management module 308 includes a datastore 510 that stores data associated with services and dependency information, a scaling ratio determination module 520 that determines scaling ratios for services, an allocation ratio determination module 530 that determines allocation ratios, a dependency determination module 540 that determines dependency data among services, a scaling coordinating module 550 that coordinates the operations in a scaling process, a load balancing module 560 that balances resources among services based on capacity, a cluster provisioning module 570 that migrates services among clusters, and an alert and notification module 570 that generates alerts if a service is approaching capacity. The modules shown in FIG. 5 are non-limiting and are for illustrative purposes only; more or fewer modules may be used to achieve the functionality described herein.

Datastore 510 stores data associated with services and stores dependency information. In one embodiment, datastore 510 stores dependency data associated with the services. Dependency data describes the dependencies among various services. If a first service receives and processes requests from a second service, then the second service may be referred to as dependent on (i.e., depends on) the first service. Dependency data may be stored as a tree structure, as a dependency graph, or may be stored in one or more data tables or any other type of data structure. As an example, dependency data may include information indicating that service A depends on service B, and service B further depends on service C. A service may depend on multiple services and multiple services may depend on one single service. For a set of services that depend on each other, such as in the example where service A depends on service B, which further depends on service C, service A may be referred to as the upmost level and service C may be referred to as the bottommost level.

Datastore 510 may further store allocation ratios associated with each service. As each service may be distributed across multiple clusters, the ratio of the service allocated on each cluster may be referred to as an allocation ratio. For example, 60% of service A may be processed by a first cluster, and 40% percent of service A may be processed by a second cluster, in which case a ratio of 6:4 may be referred to as the allocation ratio for service A. In one embodiment, each cluster contains various services based on the allocation ratios, where the services may call each other locally within the cluster. For example, a service A may call a service B in the same cluster instead of calling service B from a different cluster. Each cluster may operate independently with services calling each other within the same cluster, which improves efficiency by reducing communication between clusters and therefore saving network resources. Further details regarding allocation ratios are discussed in accordance with allocation ratio determination module 530.

Allocation ratio determination module 530 may determine allocation ratios for a service. In one embodiment, allocation ratios are predetermined by humans. Allocation ratio determination module 530 may also determine allocation ratios based on availability of clusters. In another embodiment, allocation ratio determination module 530 may determine allocation ratios by taking stability and liability of the system into account. For example, allocation ratio determination module 530 may determine to distribute a service across multiple clusters because the deployment size of the service does not fit on one cluster. In another embodiment, even if the service may fit on one cluster, allocation ratio determination module 530 may also distribute the service across more than one cluster to optimize the stability of the system. For example, suppose a service is distributed across 4 clusters, if one cluster fails, the service loses 25% of capacity for handling requests, instead of losing all capacity if the service is allocated on one single cluster.

Dependency determination module 540 may determine dependency data associated with various services. In one embodiment, dependency data is predefined by humans. Alternatively, dependency determination module 540 may resolve (i.e., determine) dependencies based on a flow of requests among services. For example, dependency determination module 540 may detect that service B receives requests from service A and therefore determines that service A depends on B. Dependency determination module 540 may save the determined dependency information in datastore 510.

Scaling ratio determination module 520 may determine scaling ratios based on dependency data stored in datastore 510. Scaling ratio determination module 520 may further determine scaling ratios based on the amount of workload (e.g. loads) associated with each service. Scaling ratio represents the amount of scaling (e.g. number of units of resources) to adjust for affected services if the requested service scales up or down 1 unit. For example, for every unit that service A scales up, service B needs to scale up 2 units to be able to process the additional requests resulted from the scaling up of service A. As a result, to keep the chain of services function properly, for every 1 unit that service A scales up, service B may need to scale up 2 units. Then the ratio 1:2 (or 2:1) may be referred to as a scaling ratio.

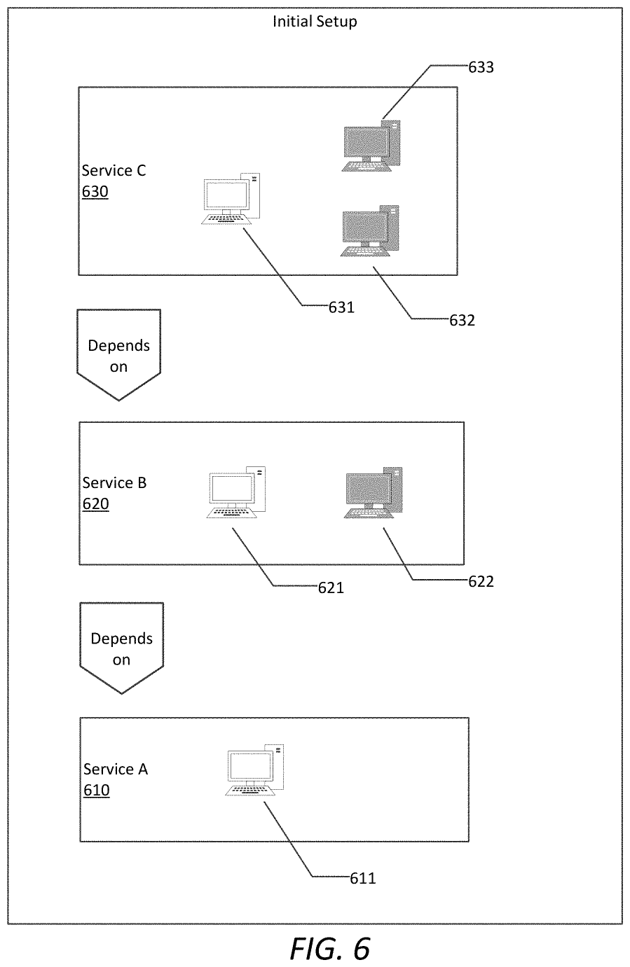

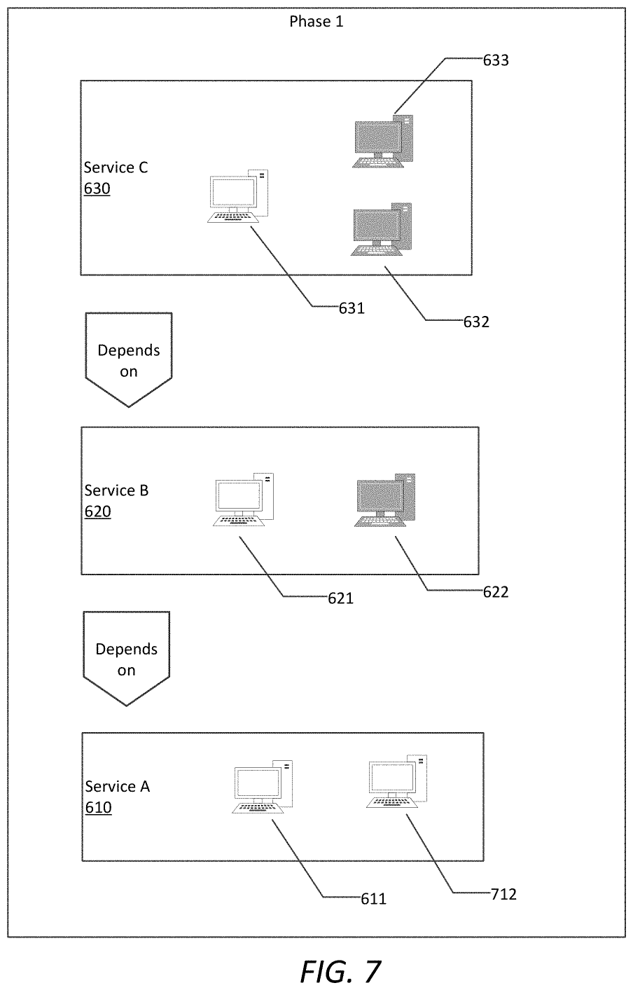

Scaling coordinating module 550 may coordinate scaling operations associated with a scaling request received by the content item management module 308. Scaling coordinating module 550 may perform operations to scale one or more services based on various information such as dependency data, allocation ratio, scaling ratio, and scaling factor. FIGS. 6-9 illustrate an exemplary process for scaling up a service C that depends on other services, with FIG. 6 illustrating an initial configuration of the system, and FIG. 7-9 illustrating a series of steps that scaling coordinating module 500 performs to scale up service C.

FIG. 6 illustrates an exemplary initial configuration for a system involving service A, B and C, with service C depending on service B, which further depends on service A. As illustrated in FIG. 6, service A may be referred to as the bottommost level and service C may be referred to as the topmost level. Service A may also be referred to as a higher tiered level comparing to Service B and C, and service B may be referred to as a higher tiered level for service C. In an alternative embodiment, each level may include more than one services. For example, service C′ may also depend on service B and the topmost level may include both service C and C′. Each of the services A, B and C is distributed across one or more clusters (illustrated with machines in two different colors.) The machines in the figure are for illustration purposes and each machine does not necessarily represent one computer device but is rather used to illustrate one unit of processing power. For example, service C is distributed across two clusters, where machine 631 (i.e., a unit of processing power) is from a first cluster (illustrated with a white computer shape) and machines 632-633 are from a second cluster (illustrated with a shaded computer shape.) Similarly, service B is distributed across cluster 1 (machine 621) and cluster 2 (machine 622), and service A located only on cluster 1 (machine 611).

As illustrated in FIG. 6, dependency data for the system may include a dependency graph indicating that service C 630 depends on service B 620, which further depends on service A 610. The allocation ratio for service A is 100% on cluster 1. Allocation ratio for service B is (1:1) for (cluster 1, cluster 2) because 50% of service B is processed by cluster 1 and 50% is processed by cluster 2. Allocation ratio for service C is (1:2) or (0.33:0.67) for (cluster 1, cluster 2) because 33% of service C is processed by cluster 1 and 67% of service C is processed by cluster 2.

In one embodiment, scaling ratio between services A, B and C may be determined based on workloads associated with the services. For example, if for every 3 units that service C scales up, service B needs to scale up 2 units and service A needs to scale up 1 unit, then scaling ratio for (service A, service B, service C) is (1:2:3), which indicates that for every 3 units of increase in computing resources for service C, service B needs to scale up 2 units, and service A needs to scale up 1 unit.

FIGS. 7-9 illustrate a series of steps for scaling up service C. For example, scaling coordinating module 550 may receive a request to scale up service C by 100% (i.e. double the computing resources for service C). Scaling coordinating module 500 may first determine, based on dependency data, that scaling service C further involves scaling services A and B because service C depends on services A and B. Scaling coordinating module 550 may further determine based on dependency data that an order to scale up the chain of services is from the bottommost level to the topmost level (i.e. scaling service A first, then service B, and scale service C the last.) This can ensure that none of the services in the chain get overloaded during the scaling process. For example, assuming that service C is scaled up first without scaling up A and B, then the requests sent by service C may not be able to be processed by service A and B as they may not have enough computing resources to handle the requests. Thus, to avoid this undesirable effect, scaling coordinating module 550 may scale up services in an order that is from bottommost level to topmost level. Similarly, scaling coordinating module 550 may scale down services in an order that is from the topmost level to the bottommost level because if services in the bottommost level are scaled down first, services that depend on the service in the bottom level may be overloaded.

FIG. 7 illustrates a first phase for scaling up service C. Because for every 3 units that service C scales up, service B needs to scale up 2 units and service A needs to scale up 1 unit. In FIG. 7, scaling coordinating module 550 may first scale up service A 610 with one unit of processing power (i.e. illustrated with machine 712.) Because allocation ratio for service A is 100% on cluster 1, the one additional unit is assigned to be processed by cluster 1.

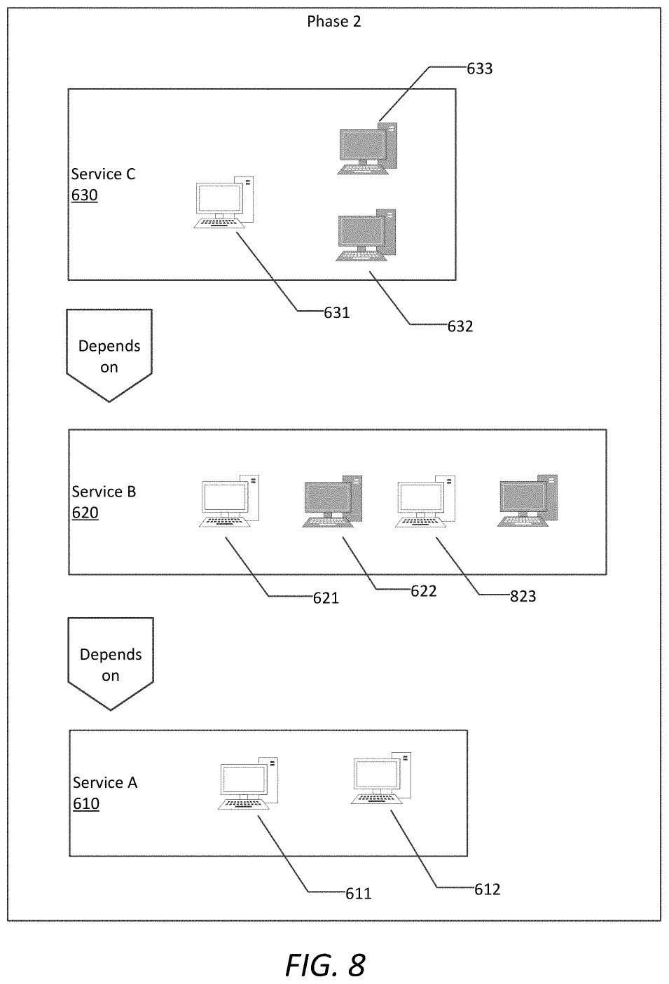

Continuing to FIG. 8, scaling coordinating module 550 may scale up service B with two additional units (i.e. illustrated with machines 823 and 824) based on the scaling ratio. Scaling coordinating module 550 may further distribute the two additional processing units across two clusters based on the allocation ratio (e.g. 1:1) for service B. As a result, processing unit 823 is illustrated with a white machine indicating that it locates on cluster 1, while processing unit 824 is illustrated with a shaded machine indicating that it locates on cluster 2.

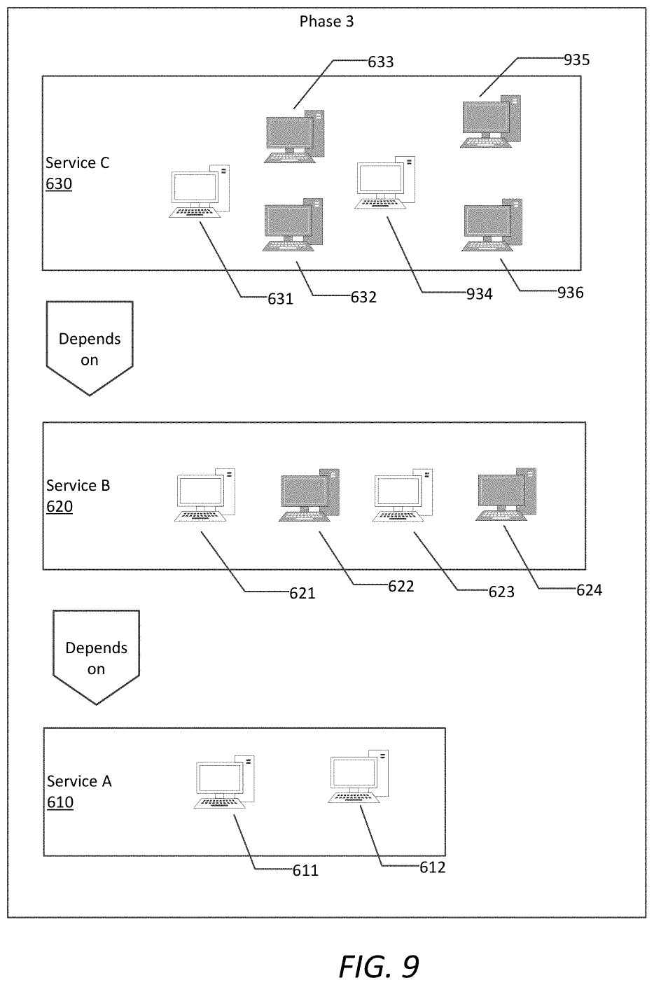

FIG. 9 illustrates the last phase for the exemplary scaling process, where service C 630 is scaled up by 3 processing units 934, 935, 936 based on scaling ratio. Scaling coordinating module 550 further determine, based on the allocation ratio (e.g. 1:2) for service C, that one processing unit may come from cluster 1 and two processing units may come from cluster 2.

The exemplary process shown in FIGS. 6-9 illustrates a scaling up process and the services are scaled up from the bottommost level to the topmost level. In a scaling down process, scaling coordinating module 550 may scale down the services from topmost level to bottommost level. For example, if the scaling coordinating module 550 receives a request to scale down service A by 50%, scaling coordinating module 550 may scale down service C first, then scale down service B, and scale down service A the last.

In one embodiment, scaling coordinating module 550 may complete the scaling in a series of incremental steps based on a scaling factor. The scaling process may be an iterative process that, for each iterative step, scaling coordinating module 550 may scale the set of services based on the scaling factor, until a target deployment size is reached. For example, if the scaling factor is 5%, for each iterative step, scaling coordinating module 550 may scale each service by 5% of the total amount to be scaled. Each iterative step involves scaling the set of services based on the particular scaling sequence described above. Scaling coordinating module 550 may stop executing the iterative process responsive to the target deployment size being reached.

Referring back to FIG. 5 and continuing with the discussion of the various modules in content item management module 308, alert and notification module 580 may generate alerts based on workload and capacity associated with each service. If the workload for a service exceeds or approaching a predetermined threshold of capacity, alert and notification module 580 may generate and send alerts to load balance module 560 where the amount of resources allocated to each service may be adjusted. Load balance module 560 is discussed in further detail below.

Load balance module 560 may automatically balance resources among services based on capacity. In one embodiment, load balance module 560 may determine to rebalance resources among services based on alerts received from the alert and notification module 580. Responsive to receiving an alert that a first service is approaching a threshold of capacity, load balance module 560 may determine to scale up the service. In one embodiment, load balance module 560 may also reallocate resources if a service has a low utilization rate. For example, if a service only uses 10% of the resources allocated to the service, and 10% of the allocated resources is enough for the service to handle the current workload, then the load balance module 560 may scale down the service.

Cluster provisioning module 570 may provision clusters based on received requests. For example, content item management module 308 may receive a request to decommission a first cluster and reinstate a second cluster. Cluster provisioning module 570 may retrieve dependency information from datastore 510. Based on the dependency data, cluster provisioning module 570 may first scale up the service on the second cluster in a bottom to top order (i.e., from bottommost level to topmost level) and then decommission the service from the first cluster in a top to bottom order (i.e., from topmost level to bottommost level.) The cluster provisioning module 570 performs scaling up before decommissioning to ensure that the service does not have a point of failure during the decommissioning process and therefore keeping the system stable and reliable. In one embodiment, cluster provisioning module 570 may perform the provisioning process iteratively based on a scaling factor. For example, for one iterative step, cluster provisioning module 570 may scale up the service on the second cluster by the scaling factor (e.g. 5% of deployment size), and then scale down the service on the first cluster by the scaling factor. Cluster provisioning module 570 may repeat the iterative step until the first cluster is completely decommissioned.

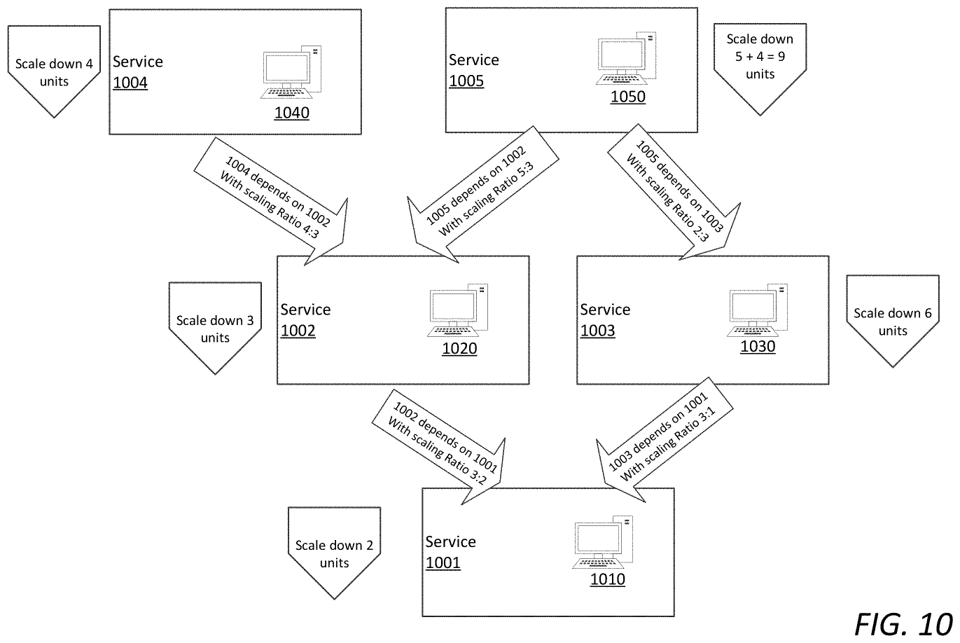

FIG. 10 is an exemplary configuration involving various services 1001-1005 that depend on each other with non-linear dependencies. Multiple services may depend on one service (e.g. services 1002 and 1003 depend on service 1001), and a service may also depend on multiple services (e.g. service 1005 depends on services 1002 and 1003). FIG. 10 also depicts exemplary scaling ratios between any two related services. As an exemplary use case, suppose a request is received to scale up service 1004 by 4 processing units. Scaling coordinating module 550 may identify based on the dependency graph that services 1002 and 1001 are affected. A scaling sequence may be determined such that the scaling up is in a bottom to top order (e.g. in the order of service 1001, 1002, 1004). Based on the scaling ratios, scaling coordinating module 550 may first scale up service 1001 by 2 units, then scale up service 1002 by 3 units, and scale 1004 by 4 units.

In one embodiment, suppose a request is received to scale down service 1001 by 2 units. Scaling coordinating module 550 may determine from dependency data that services 1001-1005 are affected by the scaling. As the request is to scale down service 1001, scaling coordinating module 550 may further determine that an order to perform the scaling is in a top to bottom (e.g. higher-tiered level to lower-tiered level) order. Based on scaling ratios, scaling coordinating module 550 may determine that for every 2 units of scaling up in service 1001, service 1002 should scale up 3 units, and service 1003 should scale up 6 units. Then for every 3 units of increase in service 1002, service 1004 should scale up 4 units, and service 1005 should scale up 5 units. Similarly, for every 6 units of scaling up for service 1003, service 1005 may be scaled up 4 units. As service 1005 depends on both service 1002 and 1003, scaling coordinating module 550 may scale down service 1005 9 units in total, combining the 5 units decrease from service 1002 and 5 units decrease from service 1003. Finally, based on the scaling ratios, scaling coordinating module 550 may first scale down services 1004 and 1005 with their respective number of units of scaling. Scaling coordinating module 550 may scale down service 1004 first or scale down service 1005 first, as services 1004 and 1005 do not depend on each other. After services 1004 and 1005 are scaled down, scaling coordinating module 550 may scale down services 1002 and 1003. And lastly, scaling coordinating module 550 may scale down service 1001 by 2 units as requested.

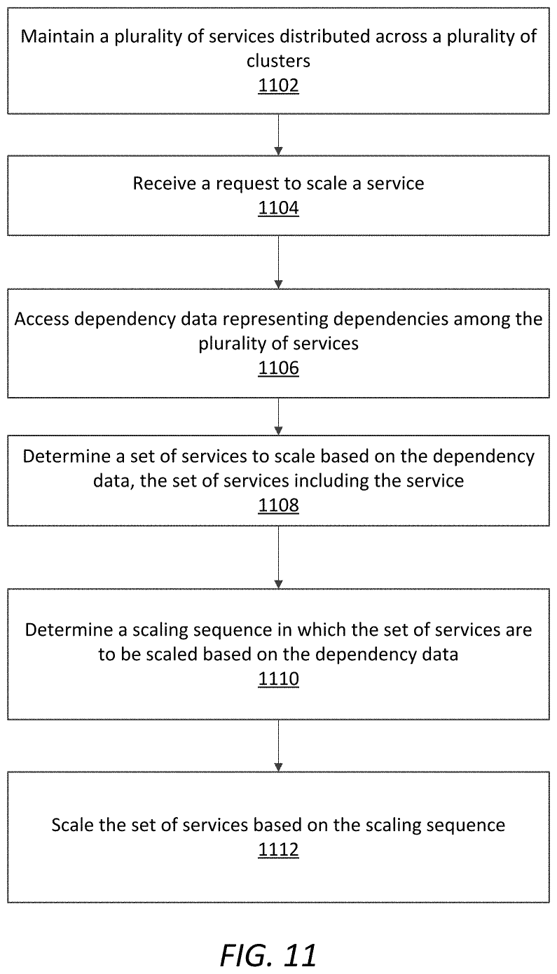

FIG. 11 is a flow chart that illustrates an exemplary process for scaling a service. The process starts with content item management module 308 maintaining 1102 a plurality of services distributed across a plurality of clusters. Each service serves a functionality in the content management system 100. Content item management module 308 may receive 1104 a request to scale a service. Content item management module 308 may access 1106 dependency data stored in data store 510, with the dependency data representing dependencies among the plurality of services. The scaling coordinating module 550 may determine 1108 a set of services including the service to scale based on the dependency data. Scaling coordinating module 550 may further determine 1110 a scaling sequence (i.e. an order for scaling) based on the dependency data. Scaling coordinating module 550 may scale 1112 the set of services based on the determined scaling sequence.

### Additional Considerations

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regards to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. It will be understood that any computer programming language may support equivalent structures using a different terminology than “module.”

It will be understood that the named modules described herein represent one embodiment of such modules, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including optical disks, CD-ROMs, read-only memories (ROMs), random access memories (RAMs), magnetic or optical cards, or any type of media suitable for storing electronic instructions, and each coupled to a computer system bus. Furthermore, the computers referred to in the specification may include a single processor or may be architectures employing multiple processor designs for increased computing capability.

The algorithms presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

As used herein, the word “or” refers to any possible permutation of a set of items. Moreover, claim language reciting ‘at least one of’ an element or another element refers to any possible permutation of the set of elements.

Although this description includes a variety of examples and other information to explain aspects within the scope of the appended claims, no limitation of the claims should be implied based on particular features or arrangements these examples. This disclosure includes specific embodiments and implementations for illustration, but various modifications can be made without deviating from the scope of the embodiments and implementations. For example, functionality can be distributed differently or performed in components other than those identified herein. This disclosure includes the described features as non-exclusive examples of systems components, physical and logical structures, and methods within its scope.

Finally, it should be noted that the language used in the specification has been principally selected for readability and instructional purposes and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method comprising:
maintaining, by a service management system, a plurality of services that are distributed across a plurality of clusters, wherein each service of the plurality of services serves a functionality in a data storage system;
receiving a request to scale a service of the plurality of services;
accessing dependency data representing dependencies among the plurality of services;
determining, based on the dependency data, a set of services of the plurality of services to scale based on a scaling of the service, the set of services including the service;
determining, by the service management system, a scaling sequence in which the set of services are to be scaled based on the dependency data; and
scaling the set of services based on the scaling sequence.

2. The method of claim 1, wherein each service of the set of services is associated with a deployment size that indicates an amount of resources consumed by the service.

3. The method of claim 2, further comprising:
determining an allocation ratio based on the deployment size associated with each service of the set of services, wherein scaling the set of services is further based on the allocation ratio.

4. The method of claim 1, wherein scaling the set of services further comprises:
determining a scaling factor that indicates a percentage of scaling for one iterative step; and
executing an iterative process by iteratively scaling the set of services based on the scaling factor until a target deployment size is reached.

5. The method of claim 4, further comprising:
determining a scaling ratio based on workload associated with the set of services, wherein the scaling ratio is a ratio of scaling based on workload associated with the service relative to workload associated with other services in the set of services, and wherein each iteration of the iterative process is further based on the scaling ratio.

6. The method of claim 1, wherein scaling the set of services includes scaling up or scaling down the set of services.

7. The method of claim 6, wherein the dependency data includes tiered hierarchical levels, and wherein scaling up the set of services occurs in an order from lower tiered levels to higher tiered levels and scaling down the set of services occurs in an order from higher level tiers to lower level tiers.

8. The method of claim 1, wherein scaling the set of services further comprises:
identifying a second cluster to allocate the set of services to;
scaling up the set of services on the second cluster based on the dependency information in a bottom to top order; and
scaling down the set of services on the first cluster based on the dependency information in a top to bottom order.

9. The method of claim 1, wherein the service depends on more than one other service in the set of services.

10. A non-transitory computer-readable storage medium storing executable computer instructions that, when executed by one or more processors, cause the one or more processors to perform operations, the operations comprising:
maintaining, by a service management system, a plurality of services that are distributed across a plurality of clusters, wherein each service of the plurality of services serves a functionality in a data storage system;
receiving a request to scale up a first service of the plurality of services;
accessing dependency data representing dependencies among the plurality of services;
determining, based on the dependency data, a set of services of the plurality of services to scale up based on a scaling of the service, the set of services including a second service and the first service, the second service being a bottommost service in the set of services, wherein other services in the set of services depend on the second service;
determining, by the service management system, a scaling sequence in which the set of services are to be scaled based on the dependency data; and
scaling up the set of services according to the scaling sequence, wherein the scaling sequence indicates to scale the second service before scaling another service of the set of services.

11. The non-transitory computer-readable storage medium of claim 10, wherein each service of the set of services is associated with a deployment size that indicates an amount of resource consumed by each service.

12. The non-transitory computer-readable storage medium of claim 11, wherein the operations further comprise:
determining an allocation ratio based on the deployment size associated with each service of the set of services, wherein scaling the set of services is further based on the allocation ratio.

13. The non-transitory computer-readable storage medium of claim 10, wherein the operation of scaling up the set of services further comprises operations:
determining a scaling factor that indicates a percentage of scaling for one iterative step; and
executing an iterative process by iteratively scaling the set of services based on the scaling factor until a target deployment size is reached.

14. The non-transitory computer-readable storage medium of claim 13, wherein the operations further comprise:
determining a scaling ratio based on workload associated with the set of services, wherein the scaling ratio is a ratio of scaling performed by the service relative to other services in the set of services, and wherein each iteration of the iterative process is further based on the scaling ratio.

15. The non-transitory computer-readable storage medium of claim 10, wherein the dependency data includes dependencies arranged in an order with a bottommost level and a topmost level, and wherein scaling up the set of services occurs in an order from the bottommost level to the topmost level.

16. A system comprising:
memory with instructions encoded thereon; and
one or more processors that, when executing the instructions, perform operations comprising:
maintaining, by a service management system, a plurality of services that are distributed across a plurality of clusters, wherein each service of the plurality of services serves a functionality in a data storage system;
receiving a request to decommission a cluster of the plurality of clusters, wherein a service of the plurality of services is run by the cluster;
accessing dependency data representing dependencies among the plurality of services;
determining, based on the dependency data, a set of services of the plurality of services to scale based on a scaling of the service, the set of services including the service;
identifying a second cluster from the plurality of clusters based on the second cluster having enough capacity to process requests from the set of services;
determining, by the service management system, scaling sequences in which the set of services are to be scaled based on the dependency data;
scaling up the set of services on the second cluster based on a first scaling sequence of the scaling sequences; and
scaling down the set of services on the first cluster based on a second scaling sequence of the scaling sequences.

17. The system of claim 16, wherein each service of the set of services is associated with a deployment size that indicates an amount of resource consumed by each service.

18. The system of claim 16, the operations further comprising:
determining an allocation ratio based on the deployment size associated with each service of the set of services, wherein scaling the set of services is further based on the allocation ratio.

19. The system of claim 16, wherein scaling up and scaling down the set of services further comprises:
determining a scaling factor that indicates a percentage of scaling for one iterative step; and
executing an iterative process by iteratively scaling the set of services based on the scaling factor until a target deployment size is reached.

20. The system of claim 19, the operations further comprising:
determine a scaling ratio based on workload associated with the set of services, wherein the scaling ratio is a ratio of scaling performed by the service relative to other services in the set of services, and wherein each iteration of the iterative process is further based on the scaling ratio.
